(19) United States
(12) Patent Application Publication
(10) Pub. No.: US 2019/0315436 A1
(43) Pub. Date: Oct. 17, 2019

(54) BRAKE AND SHIFT CONTROL ASSEMBLY

(71) Applicant: TEKTRO TECHNOLOGY CORPORATION, Changhua County (TW)

(72) Inventor: Po-Hsien WU, Changhua County (TW)

(21) Appl. No.: 16/190,319

(22) Filed: Nov. 14, 2018

(30) Foreign Application Priority Data
Apr. 13, 2018 (TW) 107112677

(51) Int. Cl. B62M 25/08; B62L 3/02; B62K 23/06

(52) U.S. Cl. CPC B62M 25/08; B62K 23/06; B62L 3/02

(57) ABSTRACT

The disclosure provides a brake and shift control assembly configured to be mounted on a bicycle head. The brake and shift control assembly includes a brake module and a shift control module. The brake module is mounted on one of the holding parts. The shift control module includes a signal generator, a fixing assembly, a circuit board, a wire, a battery and an antenna. The signal generator is disposed on the brake module. The fixing assembly is disposed on bicycle head. The circuit board is disposed in the fixing assembly and electrically connected to the signal generator via the wire. The battery and the antenna are disposed on the circuit board.

### CROSS-REFERENCE TO RELATED APPLICATIONS

This non-provisional application claims priority under 35 U.S.C. § 119(a) on Patent Application No(s). 107112677 filed in Taiwan, R.O.C. on Apr. 13, 2018, the entire contents of which are hereby incorporated by reference.

### TECHNICAL FIELD

The disclosure relates to a brake and shift control assembly, more particularly a brake and shift control assembly having an antenna disposed on a head tube, a stem, or a middle or holding part of a handlebar.

### BACKGROUND

In recent years, road bikes, mountain bikes and other types of bicycles are all popular in the market, and it motivates bicycle manufacturers to pay more attention on improving their products. In general, the bicycle is usually provided with derailleurs to shift the chain so as to adjust a gear ratio of front sprockets to rear sprockets. In order to precisely shift the chain and to increase the sensitivity in controlling the derailleurs, an electronic gear-shifting derailleur system is developed.

Generally, an electronic gear-shifting system electrically connects the derailleurs and the control on the handlebar via wires, such that upshift/downshift signal produced by the control can be transmitted to the derailleur.

### SUMMARY OF THE INVENTION

One embodiment of the disclosure provides a brake and shift control assembly configured to be mounted on a bicycle head. The bicycle head includes a head tube, a stem and a handlebar. The stem is mounted on the head tube. The handlebar includes two holding parts and a middle part fixed to the stem and connected to and located between the two holding parts. The brake and shift control assembly includes a brake module and a shift control module. The brake module is mounted on one of the holding parts. The shift control module includes a signal generator, a fixing assembly, a circuit board, a wire, a battery and an antenna. The signal generator is disposed on the brake module. The fixing assembly is disposed on the middle part, one of the holding parts, the head tube or the stem. The circuit board is disposed in the fixing assembly, and the circuit board is electrically connected to the signal generator via the wire. The battery and the antenna are disposed on the circuit board.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a brake and shift control assembly and a handlebar according to a first embodiment of the disclosure;

FIG. 2 is a partially exploded view of a shift control module in FIG. 1;

FIG. 3 is a top view of a circuit board, a battery and an antenna in FIG. 2;

FIG. 4 is a partial perspective view of the brake and shift control assembly in FIG. 1;

FIG. 5 is a perspective view of a brake and shift control assembly and a handlebar according to a second embodiment of the disclosure;

FIG. 6 is a partial perspective view of a casing and a wire in FIG. 5;

FIG. 7 is a perspective view of a brake and shift control assembly and a handlebar according to a third embodiment of the disclosure;

FIG. 8 is a partially exploded of a shift control module in FIG. 7;

FIG. 9 is a perspective view of a brake and shift control assembly and a handlebar according to a fourth embodiment of the disclosure;

FIG. 10 is a partially exploded view of a shift control module in FIG. 9;

FIG. 11 is a perspective view of a brake and shift control assembly and a bicycle head according to a fifth embodiment of the disclosure;

FIG. 12 is a partially exploded view of a shift control module and the bicycle head in FIG. 11;

FIG. 13 is a perspective view of a brake and shift control assembly and a bicycle head according to a sixth embodiment of the disclosure;

FIG. 14 is a partially exploded view of a shift control module in FIG. 13;

FIG. 15 is a partial perspective view of a brake and shift control assembly and a holding part of a handlebar according to a seventh embodiment of the disclosure; and

FIG. 16 is a perspective view of a brake and shift control assembly and a bicycle head according to an eighth embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

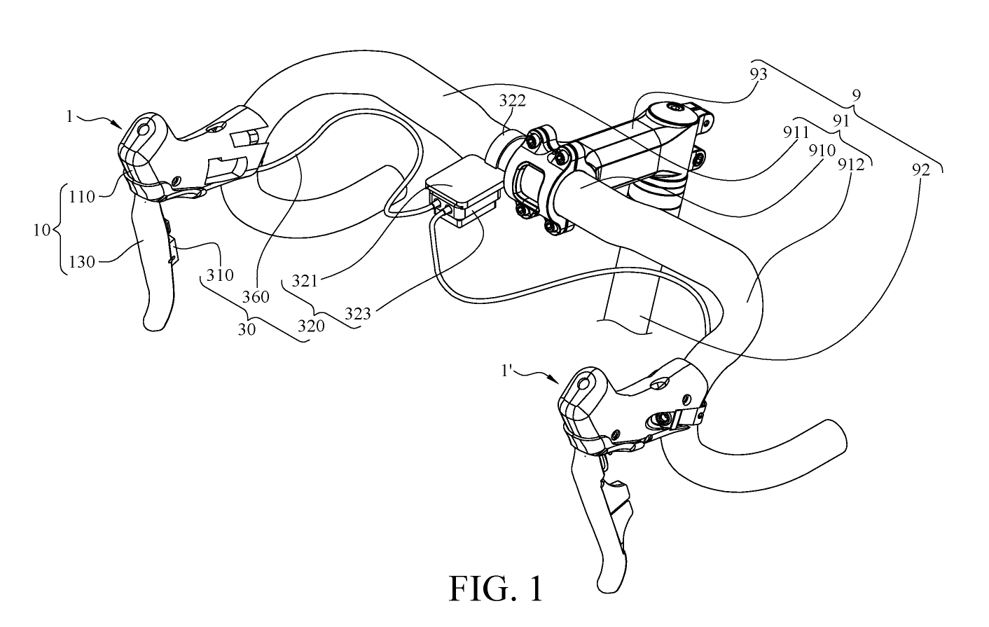

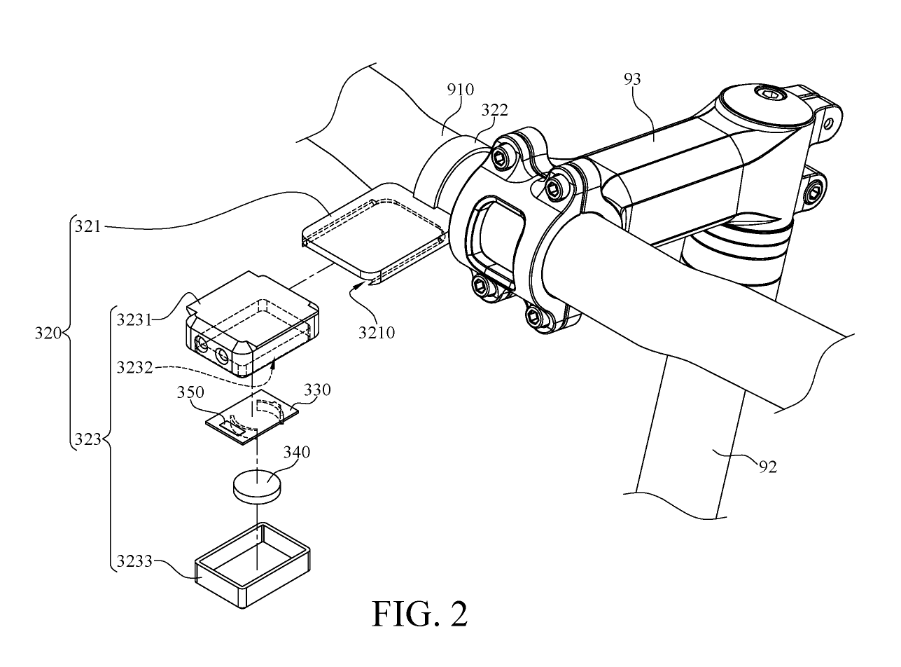

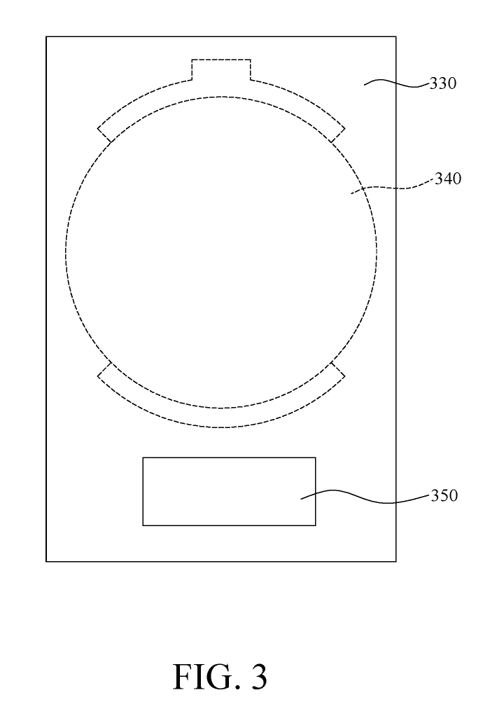

Please refer to FIG. 1 to FIG. 3. FIG. 1 is a perspective view of a brake and shift control assembly and a handlebar according to a first embodiment of the disclosure. FIG. 2 is a partially exploded view of a shift control module in FIG. 1. FIG. 3 is a top view of a circuit board, a battery and an antenna in FIG. 2.

This embodiment provides a brake and shift control assembly 1 adapted to be mounted on a bicycle head 9. The bicycle head 9 includes a handlebar 91, a head tube 92 and a stem 93. The stem 93 is mounted on the head tube 92. The handlebar 91 includes a middle part 910, a right holding part 911 and a left holding part 912. The middle part 910 is fixed to the stem 93 and is located between and connected to the right holding part 911 and the left holding part 912.

In this embodiment, each of the holding parts 911 and 912 has a portion in U-shape, but the present disclosure is not limited thereto. In some other embodiments, each of the left and right holding parts may be straight.

The brake and shift control assembly 1 includes a brake module 10 and a shift control module 30.

The brake module 10 includes a base body 110 and a brake lever 130. In this embodiment, the base body 110 is configured to be mounted on the right holding part 911 for hand to hold. The brake lever 130 is pivotally disposed on the base body 110 and is connected to a brake cable.

The shift control module 30 includes a signal generator 310, a fixing assembly 320, a circuit board 330, a battery 340, an antenna 350, a wire 360 and two shift levers 371 and 372.

The signal generator 310 is disposed on the brake lever 130. The signal generator 310 is configured to produce an upshift signal or a downshift signal to the antenna 350, and the antenna 350 is able to transmit these signals to the derailleur.

The fixing assembly 320 includes a base 321 and a casing 323. The base 321 is fixed on the middle part 910 of the handlebar 91 via a ring-shaped fastener 322 and is located adjacent to the stem 93. In this or another embodiment, the base 321 is located within 10 cm from either side of the stem 93, which can prevent the fixing assembly 320 from being too close to the holding part 911 or 912 to obstruct the movement of hand and also can prevent the fixing assembly 320 from interfering with the tape winded on the holding part 911 or 912.

The base 321 has a slot 3210. In this embodiment, the slot 3210 is, for example, in a dovetail shape, but the present disclosure is not limited thereto. The casing 323 includes a tank part 3231 and a cover part 3233. The tank part 3231 is detachably and slidably disposed on the slot 3210 of the base 321 so that the casing 323 is detachably disposed on the base 321, but the present disclosure is not limited thereto. In some other embodiments, there may be engagement structures that respectively disposed on the casing and the base to allow the casing to be detachable from the base. The cover part 3233 is detachably mounted to the tank part 3231, and the cover part 3233 and the tank part 3231 form an accommodating space 3232 therebetween.

The circuit board 330 is located in the accommodating space 3232 and fixed to the tank part 3231. The battery 340 and the antenna 350 are respectively disposed on two opposite sides of the circuit board 330. The battery 340 is located on a side of the circuit board 330 facing the cover part 3233, thus the battery 340 can be taken out of the accommodating space 3232 when the cover part 3233 is detached from the tank part 3231. In addition, as shown in FIG. 3, the projection of the battery 340 on the circuit board 330 and the projection of the antenna 350 on the circuit board 330 are non-overlapping. As such, the upshift signal or the downshift signal transmitted by the antenna 350 will not be interfered by the battery 340, thus the quality of the signal can be maintained.

One end of the wire 360 is fixed to the tank part 3231 and electrically connected to the circuit board 330, and the other end of the wire 360 is electrically connected to the signal generator 310. The signal produced by the signal generator 310 is transmitted to a derailleur via the antenna 350 in a wireless manner. The battery 340 is configured to provides electricity to the signal generator 310 and the antenna 350.

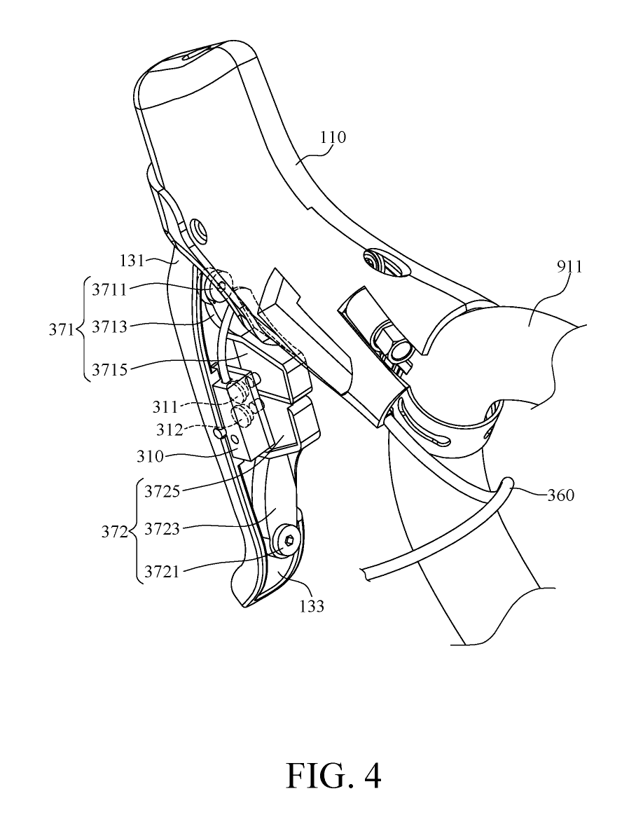

Please refer to FIG. 4. FIG. 4 is a partial perspective view of the brake and shift control assembly in FIG. 1. The shift lever 371 includes a pivot part 3711, a connecting part 3713 and a press part 3715, and the shift lever 371 includes a pivot part 3721, a connecting part 3723 and a press part 3725. The pivot parts 3711 and 3721 are respectively pivotally disposed on two opposite ends 131 and 133 of the brake lever 130 so that the shift levers 371 and 372 are able to be pivoted with respect to the brake lever 130. As such, the press parts 3715 and 3725 are respectively movable toward or away from two buttons 311 and 312 on the signal generator 310. The upshift and downshift of the derailleur can respectively be activated when the buttons 311 and 312 are respectively pressed by the press parts 3715 and 3725.

It is noted that the disclosure is not limited to the location of the fixing assembly 320 on the handlebar 91. In some other embodiments, the fixing assembly 320 is fixed on the middle part 910 but may be close to the left holding part 912.

In addition, in some other embodiments, the battery 340 and the antenna 350 may be disposed on the same side of the circuit board 330.

Furthermore, the battery 340 in the casing 323 may be rechargeable, and it can be recharged via a wire so that there is no need to detach the cover part to change the battery.

Moreover, in this embodiment, the base body 110 of the brake and shift control assembly 1 is mounted on the right holding part 911, but the present disclosure is not limited thereto. In some other embodiment, the base body may be a part of a brake and shift control assembly 1′ (e.g., in FIG. 1) and mounted on the left holding part.

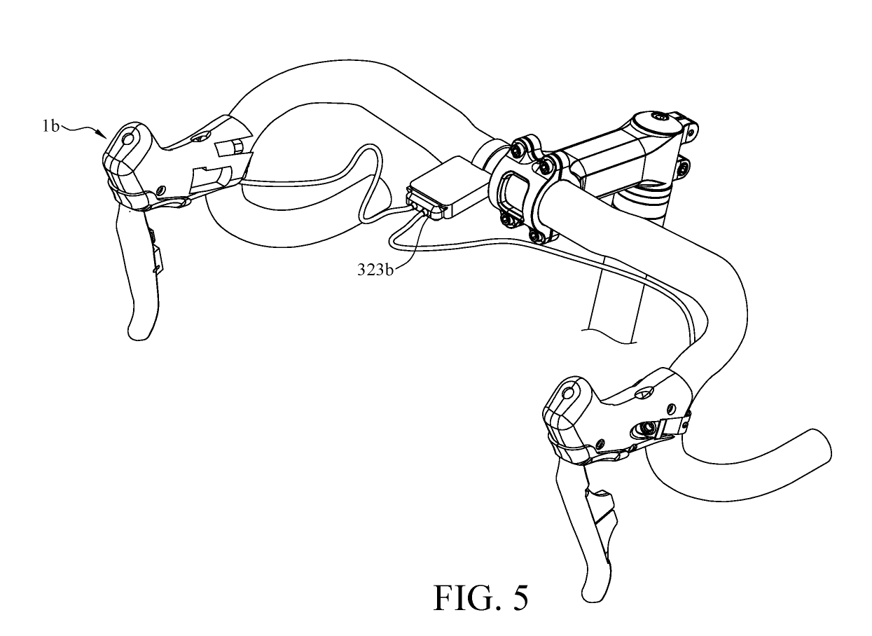

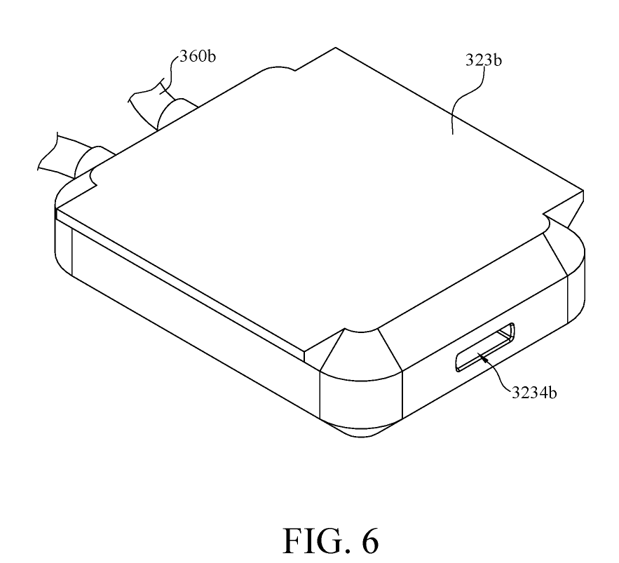

For example, please refer to FIGS. 5 and 6. FIG. 5 is a perspective view of a brake and shift control assembly and a handlebar according to a second embodiment of the disclosure. FIG. 6 is a partial perspective view of a casing and a wire in FIG. 5.

This embodiment provides a brake and shift control assembly 1b. The brake and shift control assembly 1b is similar to the brake and shift control assembly 1 of the first embodiment. One of the differences between these embodiments is that the brake and shift control assembly 1b has a casing 323b containing a rechargeable battery so that, in this embodiment, there is no need to take out the battery. In detail, the casing 323b has a charge connector 3234b electrically connected to the circuit board (not shown in figures) therein. A cable (not shown) connected to an external device can be plugged into the charge connector 3234b for charging the battery in the casing 323b. Meanwhile, the firmware (not shown) in the casing 323b can be updated by the external device.

In this embodiment, the charge connector 3234b is a slot connector, such as a USB slot, a Type-C slot, a Micro-USB slot and a lightning slot, but the present disclosure is not limited thereto. In some other embodiments, the charge connector may be a plug connector.

Furthermore, a wire 360b is fixed to the casing 323b, but the present disclosure is not limited thereto. In some other embodiments, the wire may be detachably disposed on the casing. As such, the casing will not be limited by the wire when the wire is detached from the casing, thus the casing can be easily detached from the base and connected to the external device.

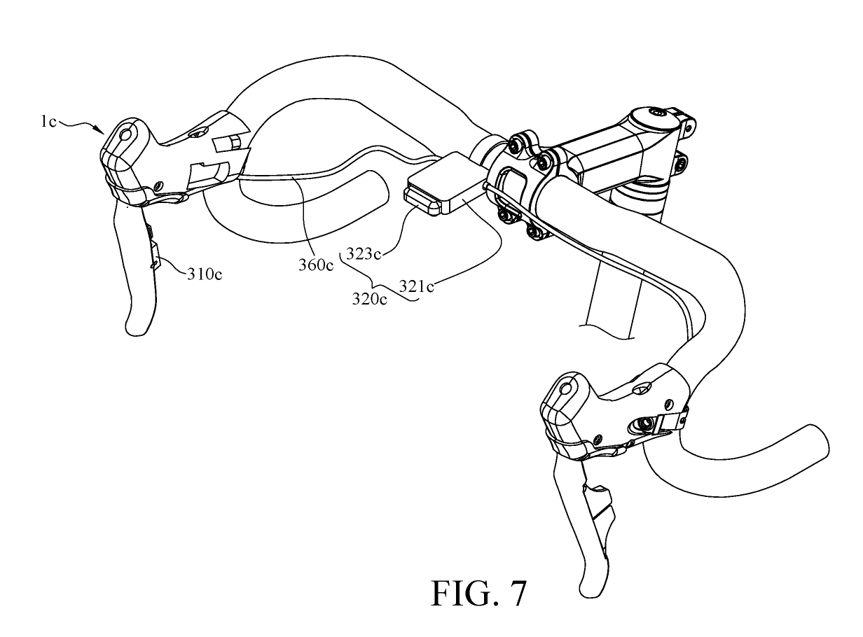

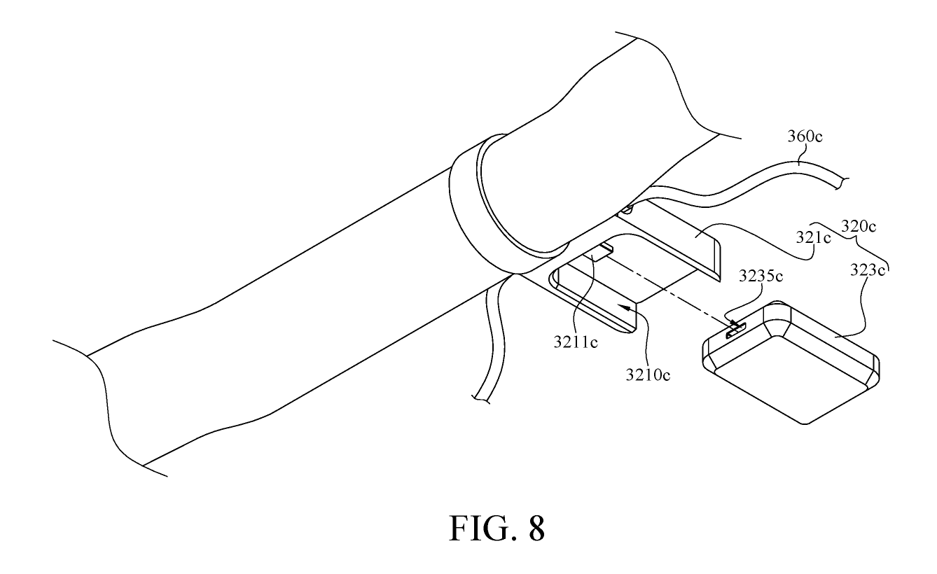

In the aforementioned embodiments, the wire is fixed to the casing of the fixing assembly, but the present disclosure is not limited thereto. In some other embodiments, the wire may be fixed to another component of the fixing assembly. For example, please refer to FIGS. 7 and 8. FIG. 7 is a perspective view of a brake and shift control assembly and a handlebar according to a third embodiment of the disclosure. FIG. 8 is a partially exploded view of a shift control module in FIG. 7

This embodiment provides a brake and shift control assembly 1c. The brake and shift control assembly 1c is similar to the brake and shift control assembly 1b of the second embodiment, and one of the differences between these two embodiments is that the brake and shift control assembly 1c provides a wire 360c fixed to a base 321c of a fixing assembly 320c. In detail, the base 321c further has a first charge connector 3211c located in a slot 3210c of the base 321c, and the wire 360c is fixed to the base 321c and electrically connected to the first charge connector 3211c. And the brake and shift control assembly 1c also provides a casing 323c having a second charge connector 3235c electrically connected to a circuit board (not shown) in the casing 323c.

When the casing 323c is located in the slot 3210c of the base 321c, the second charge connector 3235c is electrically connected to the first charge connector 3211c, such that the circuit board is electrically connected to a signal generator 310c via the second charge connector 3235c, the first charge connector 3211c and the wire 360c. In this embodiment, the first charge connector 3211c is a plug connector, and the second charge connector 3235c is a slot connector, but the present disclosure is not limited thereto. In some other embodiments, the first charge connector may be a slot connector, and the second charge connector may be a plug connector.

In addition, a cable (not shown) connected to an external device can be plugged into the second charge connector 3235c for charging the battery in the casing 323c, or upgrade the firmware (not shown) in the casing 323c.

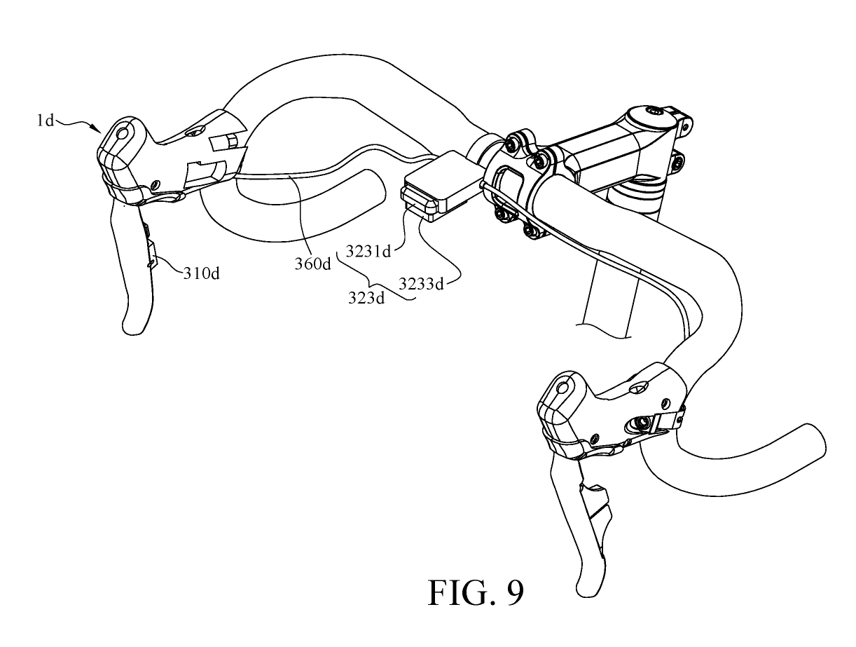

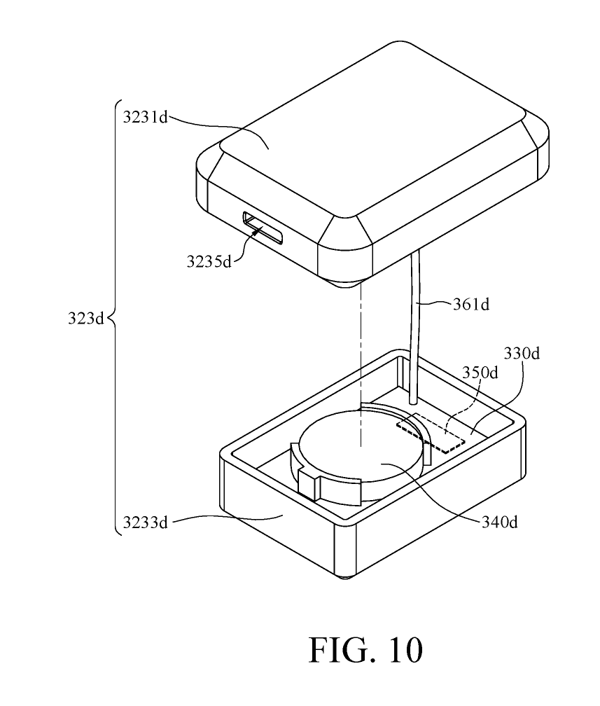

Then, please see FIGS. 9-10, FIG. 9 is a perspective view of a brake and shift control assembly and a handlebar according to a fourth embodiment of the disclosure, and FIG. 10 is a partially exploded view of a shift control module in FIG. 9. This embodiment provides a brake and shift control assembly 1d which is similar to the brake and shift control assembly 1c of the third embodiment, thus the following paragraphs only illustrate the differences therebetween. One of the differences is that the brake and shift control assembly 1d includes a casing 323d including a tank part 3231d and a cover part 3233d. The cover part 3233d is detachably mounted on the tank part 3231d. The tank part 3231d has a second charge connector 3235d, and there are a circuit board 330d, a battery 340d and an antenna 350d disposed on the cover part 3233d. In addition, in this embodiment, the circuit board 330d is electrically connected to the second charge connector 3235d via an inner wire 361d, such that the circuit board 330d is electrically connected to a signal generator 310d via the second charge connector 3235d, a first charge connector (not shown in figures) and the wire 360d.

In this embodiment, the cover part 3233d is detached from the tank part 3231d, the battery 340d is then able to be taken out from the cover part 3233d.

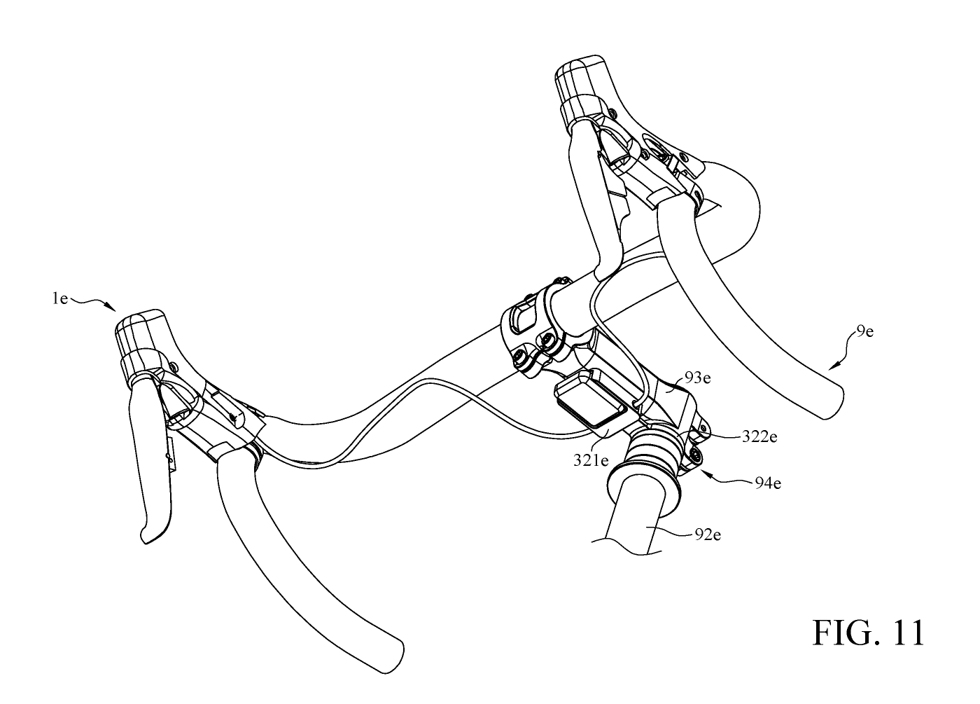

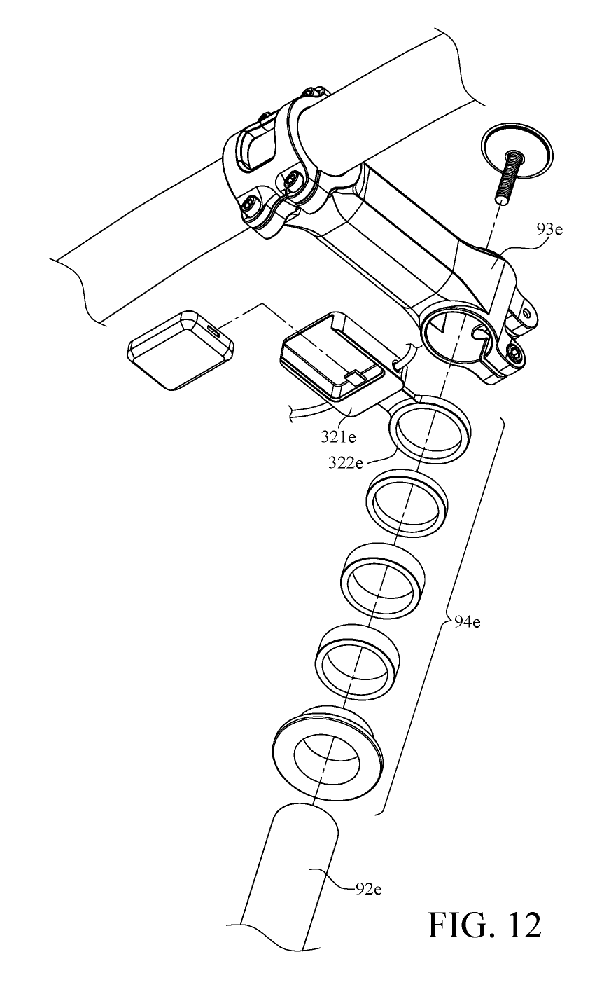

In the aforementioned embodiment, the fixing assemblies are disposed on the middle part of the handlebar, but the present disclosure is not limited. In some other embodiments, the fixing assembly may be disposed on the head tube, the stem or the holding part of the handlebar of the bicycle head. For example, please refer to FIG. 11 and FIG. 12. FIG. 11 is a perspective view of a brake and shift control assembly and a bicycle head according to a fifth embodiment of the disclosure. FIG. 12 is a partially exploded view of a shift control module and the bicycle head in FIG. 11.

This embodiment provides a brake and shift control assembly 1e. The brake and shift control assembly 1e is similar to the brake and shift control assembly 1c of the third embodiment, thus the following paragraphs only illustrate the differences therebetween. One of the differences is that the brake and shift control assembly 1e includes a base 321e fixed to a head tube 92e of a bicycle head 9e.

In detail, the base 321e is fixed to the head tube 92e via a fastener 322e, and the base 321e is located below the stem 93e. The fastener 322e also serves as a part of head parts 94e for fixing the head tube 92e. As such, there is no need for another additional fixing component to fix the base 321e on the head tube 92e, thus it can save the cost in fixing the base 321 on the head tube 92e.

In this embodiment, the fastener 322e is the part of the head parts 94e closest to the stem 93e, but the present disclosure is not limited thereto. In some other embodiments, the fastener may be another part of the head parts in a range of 15 cm from the stem.

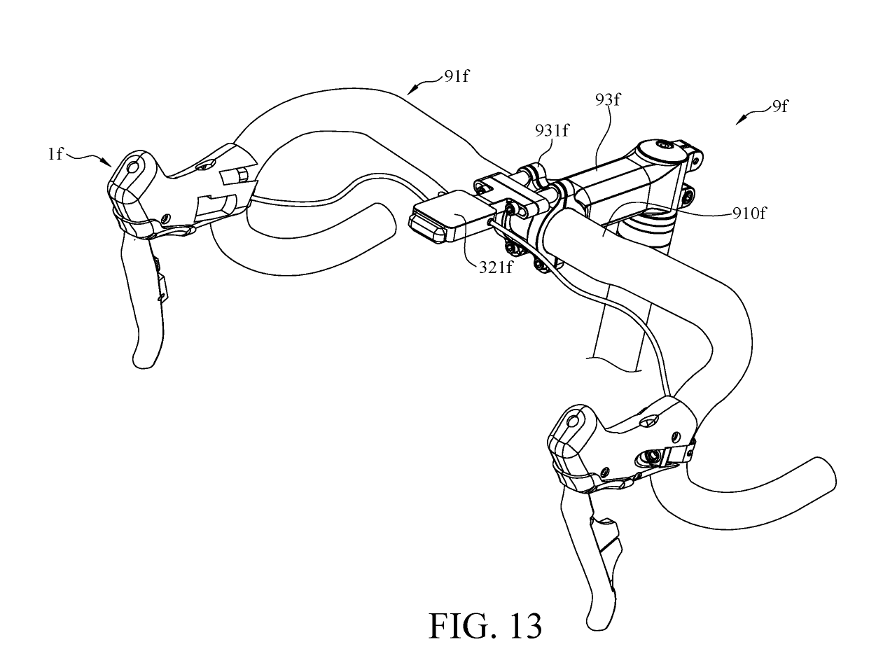

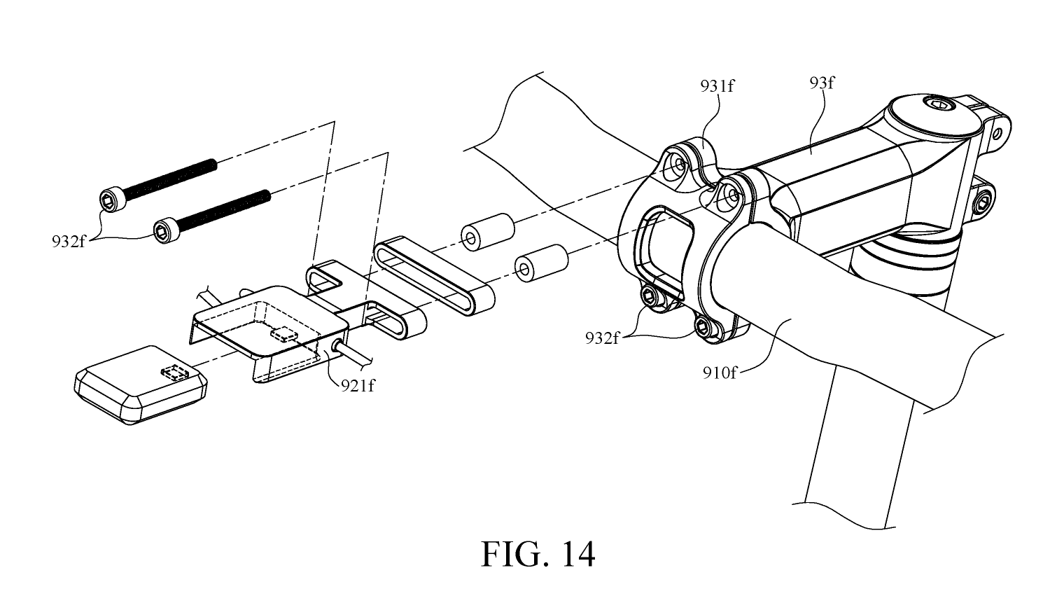

Then, please refer to FIGS. 13 and 14. FIG. 13 is a perspective view of a brake and shift control assembly and a bicycle head according to a sixth embodiment of the disclosure. FIG. 14 is a partially exploded view of a shift control module and the bicycle head in FIG. 13.

This embodiment provides a brake and shift control assembly 1f. The brake and shift control assembly if is similar to the brake and shift control assembly 1e of the fifth embodiment, thus the following paragraphs only illustrate the differences therebetween. One of the differences is that the brake and shift control assembly if includes a base 321f fixed to a stem 93f of a bicycle head 9f.

In detail, the stem 93f has a clamp component 931f and four screws 932f. A middle part 910f of a handlebar 91f is clamped by the clamp component 931f, and the screws 932f are screwed into the clamp component 931f so as to fix the handlebar 91f to the stem 93f. In this embodiment, the base 321f is fixed on the clamp component 931f of the stem 93f by two of the screws 932f, which helps the base 321f to be fixed to the stem 93f, and there is no need to form an additional screw hole on the stem 93 to install the base 321f, thereby reducing the cost in fixing the base 321f to the stem 93f.

However, the disclosure is not limited thereto. In some other embodiments, the base 321f may be fixed to the clamp component 931f by the other two screws 932f.

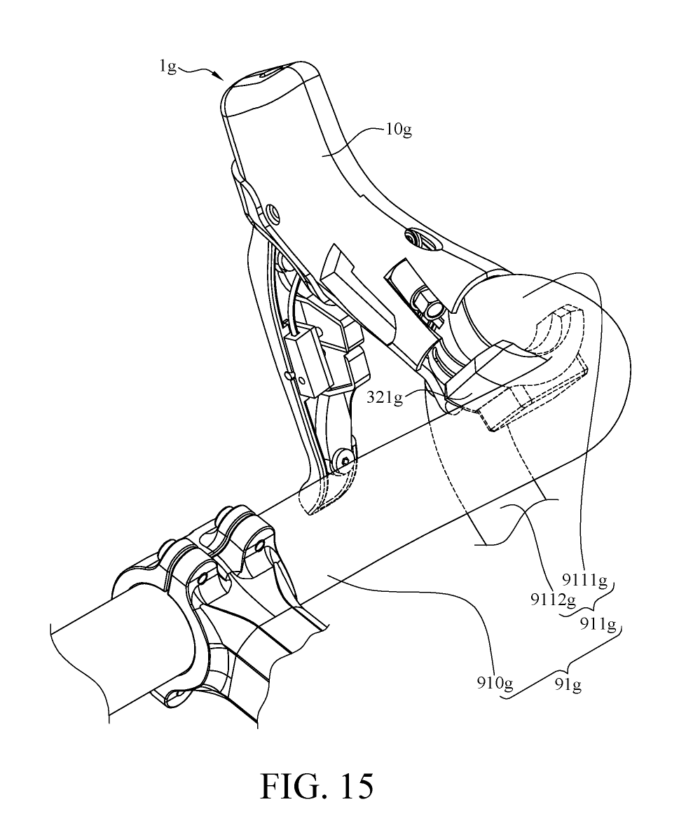

Then, please refer to FIG. 15. FIG. 15 is a partial perspective view of a brake and shift control assembly and a holding part of a handlebar according to a seventh embodiment of the disclosure.

This embodiment provides a brake and shift control assembly 1g. The brake and shift control assembly 1g is similar to the brake and shift control assemblies of the previous embodiments, thus the following paragraphs only illustrate the differences therebetween. One of the differences is that the brake and shift control assembly 1g provides a base 321g disposed on a holding part 911g of a handlebar 91g. In detail, the holding part 911g includes a connecting portion 9111g and a holding portion 9112g connected to each other, and the connecting portion 9111g is connected to a middle part 910g of the handlebar 91g. A brake module 10g and the base 321g are respectively disposed on two opposite sides of the connecting portion 9111g.

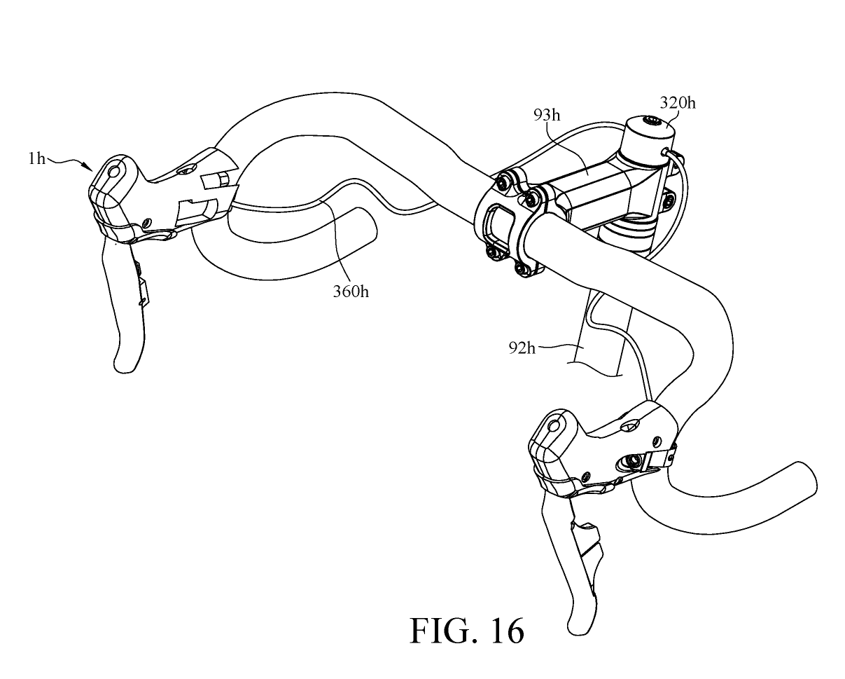

Then, please refer to FIG. 16. FIG. 16 is a perspective view of a brake and shift control assembly and a bicycle head according to an eighth embodiment of the disclosure.

This embodiment provides a brake and shift control assembly 1h. The brake and shift control assembly 1h is similar to the brake and shift control assemblies of the previous embodiments, thus the following paragraphs only illustrate the differences therebetween. One of the differences is that the brake and shift control assembly 1h provides a fixing assembly 320h disposed on a head tube 92h and located above a stem 93h. In detail, the fixing assembly 320h is a stem cap, and a circuit board, a battery and an antenna are disposed in the fixing assembly 320h. A wire 360h is detachably disposed on the fixing assembly 320h and electrically connected to the circuit board. As such, the fixing assembly 320h will not be limited by the wire 360h when the wire 360 is detached from the fixing assembly 320h, thus the fixing assembly 320h can be easily detached from the head tube 92h and connected to the external device for charging the battery.

In addition, by the fixing assembly being the stem cap, the fixing assembly can not only provide the dustproof effect and the waterproof effect, but also utilize a space inside the stem cap.

According to the brake and shift control assembly as discussed above, since the shift control module has the antenna and is disposed on the bicycle head, the upshift/downshift signal can be transmitted to the derailleur in a wireless manner, thereby providing a wireless and tangle-free experience and an aesthetic appearance of the bicycle.

In addition, the antenna and the battery are disposed on two opposite sides of the circuit board, and the projection of the antenna and the projection of the battery on the circuit board are non-overlapping, thus the upshift/downshift signal transmitted by the antenna will not be interfered by the battery, thereby maintaining the quality and efficiency of the signal.

Moreover, the base can be incorporated into the head parts or the clamp component of the stem or be a stem cap, such that there is no need for producing components for fixing the base, thus the cost in fixing the base can be reduced.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A brake and shift control assembly, configured to be mounted on a bicycle head, the bicycle head comprising a head tube, a stem and a handlebar, the stem mounted on the head tube, the handlebar comprising two holding parts and a middle part fixed to the stem and connected to and located between the two holding parts, the brake and shift control assembly comprising:
a brake module mounted on one of the holding parts; and
a shift control module comprising a signal generator, a fixing assembly, a circuit board, a wire, a battery and an antenna, wherein the signal generator is disposed on the brake module, the fixing assembly is disposed on the middle part, one of the holding parts, the head tube or the stem, the circuit board is disposed in the fixing assembly, the circuit board is electrically connected to the signal generator via the wire, and the battery and the antenna are disposed on the circuit board.

2. The brake and shift control assembly according to claim 1, wherein the fixing assembly comprises a base and a casing, the base is fixed on the middle part, one of the holding parts, the head tube, or the stem, the casing is disposed on the base, and the circuit board, the battery and the antenna are disposed in the casing.

3. The brake and shift control assembly according to claim 2, wherein the casing is detachably disposed on the base.

4. The brake and shift control assembly according to claim 3, wherein the base has a slot, and the casing is slidably disposed in the slot.

5. The brake and shift control assembly according to claim 2, wherein one end of the wire is fixed to the casing and electrically connected to the circuit board.

6. The brake and shift control assembly according to claim 5, wherein the casing comprises a tank part and a cover part, the cover part is detachably mounted on the tank part, the cover part and the tank part form an accommodating space, the circuit board, the battery and the antenna are disposed in the accommodating space, the battery is located on a side of the circuit board facing to the cover part, and the end of the wire is fixed to the tank part and electrically connected to the circuit board.

7. The brake and shift control assembly according to claim 5, wherein the casing has a charge connector configured to be electrically connected to an external device.

8. The brake and shift control assembly according to claim 5, wherein the base is fixed on the middle part.

9. The brake and shift control assembly according to claim 2, wherein the base has a first charge connector, the casing has a second charge connector, the second charge connector is electrically connected to the first charge connector, one end of the wire is fixed to the base and electrically connected to the first charge connector, and the circuit board is electrically connected to the second charge connector.

10. The brake and shift control assembly according to claim 9, wherein the casing comprises a tank part and a cover part, the second charge connector is located in the tank part, the cover part is detachably mounted on the tank part, and the circuit board, the battery and the antenna are disposed on the cover part.

11. The brake and shift control assembly according to claim 9, wherein the base is fixed on the middle part.

12. The brake and shift control assembly according to claim 9, wherein the base is fixed on the head tube and located below the stem.

13. The brake and shift control assembly according to claim 9, wherein the base is fixed on the stem.

14. The brake and shift control assembly according to claim 2, wherein each of the holding parts comprising a connecting portion and a holding portion which is connected to the middle part via the connecting portion, and the brake module and the base are disposed on one of the connecting portions.

15. The brake and shift control assembly according to claim 1, wherein the fixing assembly is disposed on the head tube and located above the stem, and one end of the wire is fixed on the fixing assembly and electrically connected to the circuit board.

16. The brake and shift control assembly according to claim 1, wherein the antenna and the battery are respectively disposed on two opposite sides of the circuit board.

17. The brake and shift control assembly according to claim 1, wherein the projection of the antenna on the circuit board and the projection of the battery on the circuit board are non-overlapping.

18. The brake and shift control assembly according to claim 1, wherein the brake module comprises a base body and a brake lever, the base body is mounted on one of the holding parts, the brake lever is pivotally disposed on the base body, the signal generator is disposed on the brake lever, the shift control module further comprises two shift levers, each of the shift levers comprises a pivot part and a press part, the pivot parts of the shift levers are respectively pivotally disposed on two opposite ends of the brake lever so as to allow the two press parts to be movable toward or away from two buttons on the signal generator.
